(19) United States
(12) Patent Application Publication
(10) Pub. No.: US 2015/0227998 A1
(43) Pub. Date: Aug. 13, 2015

(54) SYSTEM FOR BUYING AND SELLING POSITIONS IN LINE

(71) Applicants: Daniel Joseph Hartley, Boston, MA (US); Stefano Martini, Suffield, CT (US); Allan A. Campbell, Wilbraham, MA (US); Stacey E. Averbuch, New York, NY (US)

(72) Inventors: Daniel Joseph Hartley, Boston, MA (US); Stefano Martini, Suffield, CT (US); Allan A. Campbell, Wilbraham, MA (US); Stacey E. Averbuch, New York, NY (US)

(21) Appl. No.: 14/619,966

(22) Filed: Feb. 11, 2015

Related U.S. Application Data
(60) Provisional application No. 61/938,589, filed on Feb. 11, 2014.

(51) Int. Cl. G06Q 30/06

(52) U.S. Cl. CPC G06Q 30/0611

(57) ABSTRACT

An efficient system that embodies a method for securing a transaction for a position of a placeholder in a predetermined line is provided. The system facilitates the orderly exchange of the position in the predetermined line for something of value, such as money, by collecting buyer and seller exchange data of potential trading partners and determining an acceptable match thereof based on, at least in part, the exchange data collected. The exchange data may include buyer and seller (placeholder) information about the positions in the predetermined line that are desired and held, their respective offers for each position, and the time the positions and offers are valid for. The method may be adapted to prompt the potential trading partners of the acceptable match to consummate the transaction in becoming bona fide buyer and seller, and providing at least one mechanism for physically connecting the bona fide buyer and seller to exchange the position in line in accordance with their respective offers.

### CROSS-REFERENCE TO RELATED APPLICATION

This application claims the benefit of priority of U.S. provisional application No. 61/938,589, filed 11 Feb. 2014, the contents of which are herein incorporated by reference.

### BACKGROUND OF THE INVENTION

The present invention relates to commodity exchange systems and, more particularly, to an efficient system that embodies an orderly method for buying and selling positions in lines.

Currently, Americans spend an estimated 37 billion hours each year waiting in line. This is equivalent to approximately 30 minutes per day for every man, woman and child in the United State alone; accumulating to nearly 2 years spent in line over an average lifespan. The wait represents waste of the most precious commodity we all have which is time.

Although mobile technology such as smart phones and other mobile devices have helped make wait time more productive by providing gaming, news and overall access to work, home and friends, these devices have not addressed the root cause of the wait itself—the inability to efficiently and orderly change your position in line.

Currently there is no process to manage one's position in a line, except through an informal set of rules, mostly following a first in, first out [FIFO] protocol. This model leaves no room for negotiating, leveraging or mitigating the different utilities and values individuals subscribe to time spent waiting in line. In situations where FIFO breaks down, where the various needs, pressures and desires of people waiting in line trump their respect and belief in the FIFO model, we see lines deteriorate into disorder with people cheating (cutting), information-deficient buying (scalping) or confrontation to gain higher priority, because there is no orderly system for efficiently managing the exchange of a position in a line.

Moreover, scalping is not only illegal in many jurisdictions but also primarily limited to the ticket resale for admission into events (sporting, music concerts, etc.) and therefore not applicable to the countless venues where the line is dynamic and real time (i.e., the service is provided once you reach the front of the line, not at some later point in time).

Models have been developed to allow for reservations and/or check-in—for example, at restaurants and hotels—but those are still based on FIFO (just where physical presence is not a prerequisite) with no overarching system for the placeholders to efficiently exchange their place in line.

There currently are no systemic solutions that allow for exchanging places in line within the FIFO model, and so the only other existing options to lessen wait times are reservations, patience, avoidance (going somewhere else) or disorderly behavior.

Such a system would not only allow individuals to efficiently increase their position in a pecking order and profit from extinguishing or decreasing their position therein, it would provide useful information regarding the probability and predictability of attending the events that people are lining up for.

As can be seen, there is a need for an efficient system that embodies an orderly method for buying and selling positions in lines.

### SUMMARY OF THE INVENTION

In one aspect of the present invention, a system for securing a transaction for the buying and selling of a position in a predetermine line comprises a computer having a user interface; and a program product comprising machine-readable program code for causing, when executed, the computer to perform the following process steps: prompting a plurality of users for buyer exchange data or seller exchange data, wherein each exchange data includes at least one buyer position or at least one seller position in the predetermined line that are desired or held, and their respective buyer offer or seller offer for each position; receiving said buyer exchange data or seller exchange data; determining an acceptable match between the buyer exchange data and seller exchange data of the plurality of users; sending a notification of consummation to the plurality of users having the acceptable match for consummating the transaction; receiving the two consummations of the transaction from a bona fide seller and a bona fide buyer; and providing at least one mechanism to physically connect the bona fide seller and the bona fide buyer.

In another aspect of the present invention, system for securing a transaction for the buying and selling of a position in a predetermine line comprises a computer having a user interface and a user positioning system; and a program product comprising machine-readable program code for causing, when executed, the computer to perform the following process steps: prompting a plurality of users for buyer exchange data or seller exchange data, wherein each exchange data comprises: at least one buyer position or at least one seller position in the predetermined line that are desired or held, and their respective buyer offer or seller offer for each position; and a buyer wait time and a seller wait time, respectively, regarding each position in the predetermined line that is desired or held, wherein the buyer wait time and the seller wait time by, at least in part, determining the respective user's physical proximity to the predetermined line, and wherein the buyer offer expires when the buyer wait time lapses, and wherein the seller offer expires when the seller wait time lapses; receiving said buyer exchange data or seller exchange data; determining an acceptable match between the buyer exchange data and seller exchange data of the plurality of users, wherein determining the acceptable match further comprises the buyer offer equaling or exceeding the seller offer, the seller position equaling or exceeding the buyer position, and the seller wait time equaling or exceeding the buyer wait time; sending a notification of consummation to the plurality of users having the acceptable match for consummating the transaction, wherein the consummation of the transaction from a bona fide seller and a bona fide buyer includes an agreement to be bound by their respective exchange data received; receiving the two consummations of the transaction from a bona fide seller and a bona fide buyer; and providing at least one mechanism to physically connect the bona fide seller and the bona fide buyer, wherein the at least one mechanism comprises a unique identifier to and a form of electronic communication between each bona fide user.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of a seller's process of the present invention;

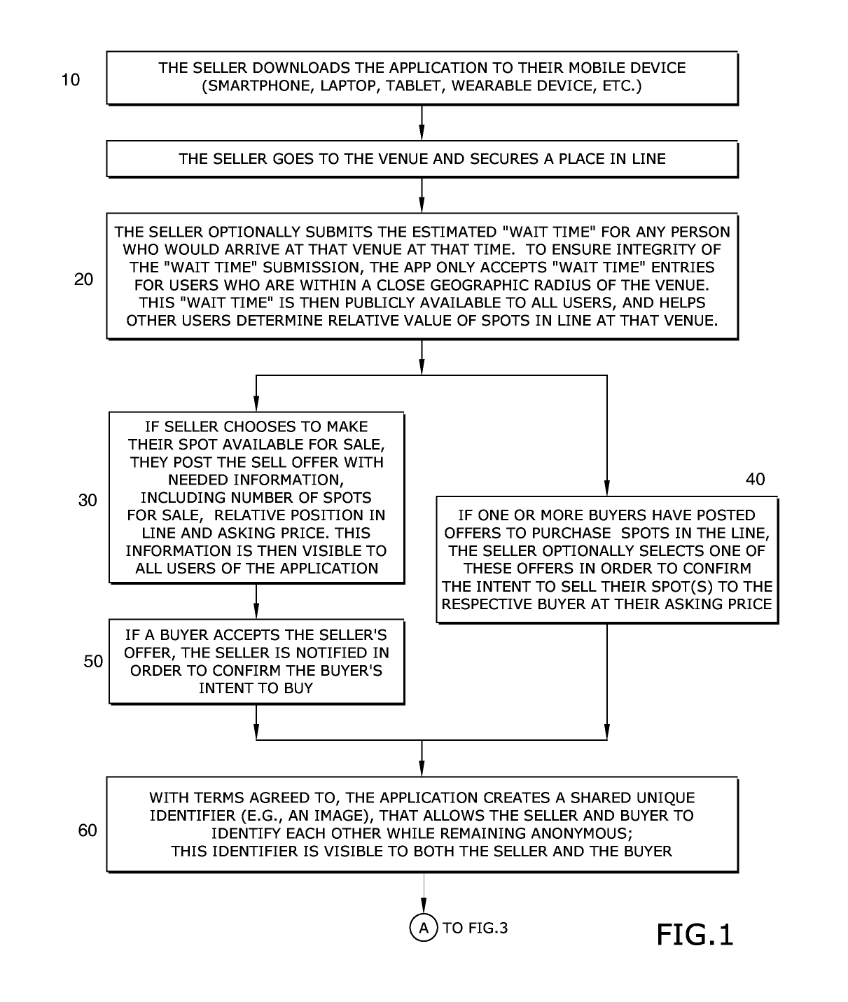

FIG. 2 is a flow chart of an exemplary embodiment of a buyer's process of the present invention; and

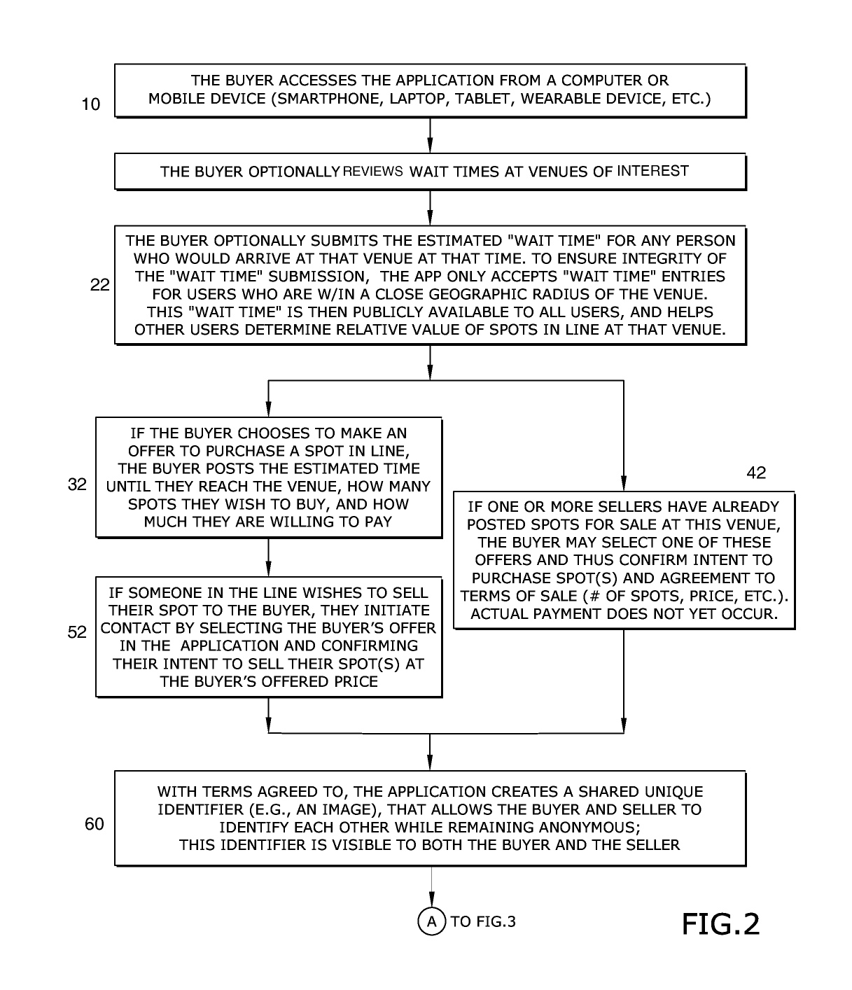

FIG. 3 is a continuation of FIG. 1 and FIG. 2 flow charts of an exemplary embodiment of the present invention.

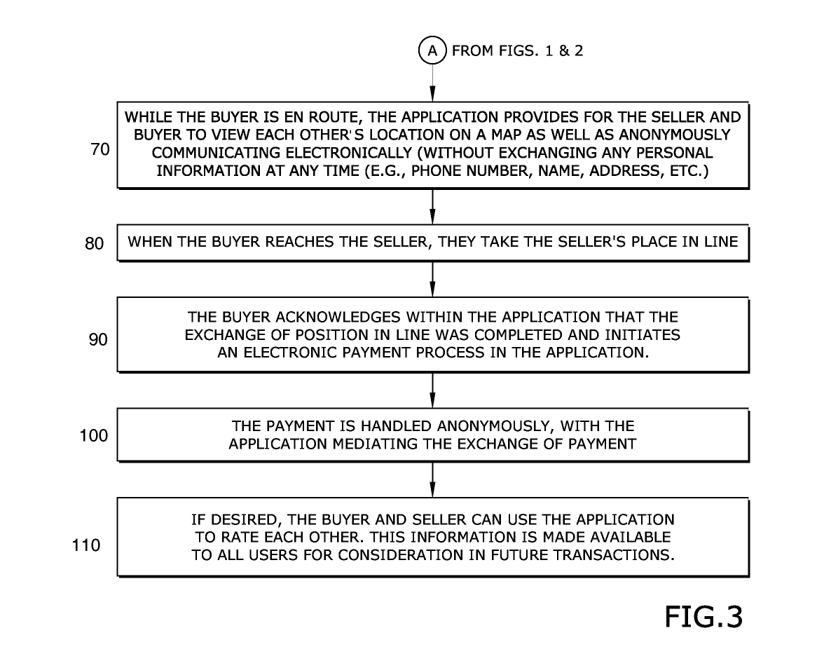

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an efficient system that embodies a method for securing a transaction for a position of a placeholder in a predetermined line. The system facilitates the orderly exchange of the position in the predetermined line for something of value, such as money, by collecting buyer and seller exchange data of potential trading partners and determining an acceptable match thereof based on, at least in part, the exchange data collected. The exchange data may include buyer and seller (placeholder) information about the positions in the predetermined line that are desired and held, their respective offers for each position, and the time the positions and offers are valid for. The method may be adapted to prompt the potential trading partners of the acceptable match to consummate the transaction in becoming bona fide buyer and seller, and providing at least one mechanism for physically connecting the bona fide buyer and seller to exchange the position in line in accordance with their respective offers.

The system may include at least one computer with a user interface. The computer may provide at least one processor having a form of memory including, but not limited to, a desktop, laptop, and smart device, such as, a tablet, smart phone, smart watch and the like. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The system may embody a method for securing a transaction for at least one position in a predetermined line for an event. The event may include, but not be limited to, sporting, entertainment, political, governmental, or any event for which a line forms for access to the event. The at least one position may be held by a placeholder (seller). The method may be adapted to include a collection of exchange data. The computer may facilitate the collection through all means known in the art including but not limited to prompting a user over a user interface, utilizing user positioning systems of the computer, and the like. The exchange data may include buyer exchange data and seller exchange data. The exchange data may be continually updated up until consummation of the transaction.

The buyer exchange data may include a buyer position, a buyer time, and a buyer offer. The buyer positions may be the number of positions in the predetermined line the buyer is interested in buying. The buyer time may be the buyer's estimate of time it would take them to physically get in the predetermined line. In certain embodiments, the buyer may be a placeholder already in the predetermined line and so the buyer time would be zero. The user positioning system may be adapted to confirm the buyer's estimation of time by determining their physical proximity to the predetermined line. The buyer offer is a value the buyer assigns to the desired positions in the predetermined line. In certain embodiments, the buyer offer may expires when the buyer wait time lapses.

The seller exchange data may include a seller position, a seller time and a seller offer. The seller positions may be the number of positions in the predetermined line the seller holds. The seller time may be the seller's estimate of time it would take them to reach the front of the predetermined line. In certain embodiments, the seller may repeatedly update the seller time because the earlier estimated flow of the predetermined line as changed, the seller allows others in line to “skip” him so as to extend the seller time, or the like. The user positioning system may be adapted to confirm the seller's estimation of time by determining their physical proximity to the predetermined line. The seller offer is a value the seller assigns to the positions held in the predetermined line. In certain embodiments, the seller offer may expires when the seller wait time lapses.

The system may be adapted to maintain the public availability of the collected exchange data as long as the relevant buyer time and the seller time has not lapsed, respectively.

The method may be adapted to determine an acceptable match between potential trading partners. Potential trading partners may be at least one prospective seller (an individual holding a place in line) and at least one prospective buyer for at least one position in the predetermined line. The acceptable match may be found when the buyer offer and the seller offer are acceptable, when the buyer position and the seller position are acceptable, and when the buyer time and the seller time are acceptable. In certain embodiments, the buyer offer and the seller offer may be acceptable when the buyer offer equals or exceeds the seller offer. In certain embodiments, the buyer position and the seller position may be acceptable when the seller position (the number of positions in the predetermined line the placeholder holds) equals or exceeds the buyer position (the number of positions in the predetermined line the buyer has expressed an interest in through the collection of buyer exchange data). In certain embodiments, the seller time and the buyer time may be acceptable when the seller time equals or exceeds the buyer time. In an alternative embodiment, the buyer offer and the seller offer may be acceptable when both offers are within a certain percentage of each other, when the buyer offer is the highest of all other potential trading partners, and the like. In an alternative embodiment, the buyer time and the seller time may be acceptable, when the difference between the buyer time and the seller time is within a predetermine range. It should be understood, of course, that there exist a myriad of definitions, configurable by the system, for the acceptable match.

The system may prompt the trading partners of the determined acceptable match to agree to be bound by the exchange data as a prerequisite for a consummation of the transaction. In certain embodiments, the consummation of the transaction may include withholding monies from a user account pursuant a predetermined terms of service. In any event, the trading partners of the consummation of the transaction may be known as a bona fide seller and a bona fide buyer. In certain embodiments, the method may be adapted to send a notification of consummation to the trading partners of the determined acceptable match. Then the trading partners of the determined acceptable match can provide the consummation of the transaction.

After consummation of the transaction, the method may be adapted to provide at least one mechanism for physically connecting the bona fide seller and the bona fide buyer. The at least one mechanism may include the user positioning system electronically representing the positions of the bona fide seller and/or buyer on their respective user interfaces in a generally map-like setting. The at least one mechanism may include an association of unique identifiers with the bona fide seller and buyer, including audible and visual indicators that only the trading partners can confirm. The at least one mechanism may include a secure form of electronic communication so that the bona fide seller and buyer may transmit specifics necessary to identify each other.

After the bona fide seller and buyer have physically connected, the method may be adapted to prompt each to confirm the consummations of the transaction, triggering the exchange of a form of payment from the bona fide buyer's user account to the bona fide seller's user account.

A method of using the present invention may include providing the system disclosed above. A user may download the program product and/or loaded software on their smart device to drive the method disclosed above, in step 10. If the user is a placeholder of at least one position in the predetermined line, the user provides the seller exchange data through some method-driven collection process, in step 20. For example, the seller may submit an estimated “wait time” (seller time) for the predetermined line. In certain embodiments, the method may include verifying the integrity of the estimated “wait time” by comparing the physical location of the event with the relevant user's physical location as determined by the user position system enabled on the smart device.

The method may be adapted to that exchange data can be made publicly available to all users of the system (“posted”) so that they can estimate the possibility of affording and accessing the event at the end of the predetermined line.

In step 30, the method may be adapted so that the placeholder/prospective seller may “post” the seller exchange data, including at least one seller position and seller offer for each such position in the predetermined line.

In step 40, the method may be adapted so that prospective buyers may post buyer offers in response to said at least one position, whereby the prospective seller may select at least one buyer offer so as to send the notification of consummation to its potential buyer, facilitating the formation of the bona fide buyer.

If the prospective buyer accepts the seller offer via the notification of consummation, the method may be adapted to send a similar notification of consummation to said prospective seller, facilitating the formation of the bona fide seller, in step 50.

In step 60, the now bona fide seller and buyer may be provided a unique identifier or other mechanism for physically locating the other bona fide party to the transaction.

For users of the system interested in purchasing the position in the predetermined line from a prospective seller, the above-mentioned steps may be similar, including step 10 and step 60.

In step 22, the prospective buyer may post the buyer exchange data through the method-driven collection process, including the “wait time” buyer time, whose integrity may be verified by comparing the physical location of the event with the user position system's determination of the relevant user.

In step 32, the prospective buyer may post the at least one buyer position and the buyer offer for each thereof.

In step 42, the prospective buyer may select an already-posted seller offer, and/or send the notification of consummation to the prospective seller associated with the already-posted seller offer or with another seller offer the prospective buyer chooses, in step 52, facilitating the formation of a bona fide seller.

In step 70, the method may be adapted to route the bona fide buyer to the position in the predetermined line, including providing secure electronic communication between the bona fide parties to facilitate the routing.

In step 80, the bona fide buyer takes the position (“the exchange”) of the bona fide seller in the predetermined line.

In certain embodiments, the method may be adapted to so that at least one of the bona fide parties may acknowledge the exchange and the bona fide buyer finalizes payment, in step 90.

In certain embodiments, the method may be adapted to handle the payment anonymously, in step 100.

In certain embodiments, the method may be adapted to rate other users of the system, in step 110.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for securing a transaction for the buying and selling of a position in a predetermine line, comprising:
a computer having a user interface; and
a program product comprising machine-readable program code for causing, when executed, the computer to perform the following process steps:
prompting a plurality of users for buyer exchange data or seller exchange data, wherein each exchange data includes at least one buyer position or at least one seller position in the predetermined line that are desired or held, and their respective buyer offer or seller offer for each position;
receiving said buyer exchange data or seller exchange data;
determining an acceptable match between the buyer exchange data and seller exchange data of the plurality of users;
sending a notification of consummation to the plurality of users having the acceptable match for consummating the transaction;
receiving the two consummations of the transaction from a bona fide seller and a bona fide buyer; and
providing at least one mechanism to physically connect the bona fide seller and the bona fide buyer.

2. The system of claim 1, wherein the buyer exchange data and the seller exchange data each further includes a buyer wait time and a seller wait time, respectively, regarding each position in the predetermined line that is desired or held.

3. The system of claim 1, wherein determining the acceptable match further comprises the buyer offer equaling or exceeding the seller offer, and the seller position equaling or exceeding the buyer position.

4. The system of claim 2, wherein determining the acceptable match further comprises the buyer offer equaling or exceeding the seller offer, the seller position equaling or exceeding the buyer position, and the seller wait time equaling or exceeding the buyer wait time.

5. The system of claim 1, wherein the mechanism to physically connect the two bona fide users includes providing a unique identifier to and a form of electronic communication between each bona fide user.

6. The system of claim 2, wherein the buyer offer expires when the buyer wait time lapses, and wherein the seller offer expires when the seller wait time lapses.

7. The system of claim 1, wherein the consummation of the transaction from a bona fide seller and a bona fide buyer includes an agreement to be bound by their respective exchange data received.

8. The system of claim 2, wherein the computer further includes a user positioning system configured for confirming the buyer wait time and the seller wait time by, at least in part, determining the respective user's physical proximity to the predetermined line.

9. The system of claim 8, wherein the mechanism to physically connect the two bona fide users includes providing an electronic representation of the bona fide seller on the bona fide buyer user interface by utilizing the user positioning system.

10. A system for securing a transaction for the buying and selling of a position in a predetermine line, comprising:
a computer having a user interface and a user positioning system; and
a program product comprising machine-readable program code for causing, when executed, the computer to perform the following process steps:
prompting a plurality of users for buyer exchange data or seller exchange data, wherein each exchange data comprises:
at least one buyer position or at least one seller position in the predetermined line that are desired or held, and their respective buyer offer or seller offer for each position; and
a buyer wait time and a seller wait time, respectively,
regarding each position in the predetermined line that is desired or held, wherein
the buyer wait time and the seller wait time by, at least in part, determining the respective user's physical proximity to the predetermined line, and wherein the buyer offer expires when the buyer wait time lapses, and wherein the seller offer expires when the seller wait time lapses;
receiving said buyer exchange data or seller exchange data;
determining an acceptable match between the buyer exchange data and seller exchange data of the plurality of users, wherein determining the acceptable match further comprises the buyer offer equaling or exceeding the seller offer, the seller position equaling or exceeding the buyer position, and the seller wait time equaling or exceeding the buyer wait time;
sending a notification of consummation to the plurality of users having the acceptable match for consummating the transaction, wherein the consummation of the transaction from a bona fide seller and a bona fide buyer includes an agreement to be bound by their respective exchange data received;
receiving the two consummations of the transaction from a bona fide seller and a bona fide buyer; and
providing at least one mechanism to physically connect the bona fide seller and the bona fide buyer, wherein the at least one mechanism comprises a unique identifier to and a form of electronic communication between each bona fide user.
